(19) United States
(12) Patent Application Publication
(10) Pub. No.: US 2014/0199564 A1
(43) Pub. Date: Jul. 17, 2014

(54) FLOW BATTERY SYSTEM, AND CONTROL METHOD AND DEVICE THEREOF

(71) Applicants: Hao Tang, Sichuan (CN); Cong Yin, Sichuan (CN); Guangyou Xie, Sichuan (CN); Ting Li, Sichuan (CN); Juan Yang, Sichuan (CN); Yuan Fang, Sichuan (CN)

(72) Inventors: Hao Tang, Sichuan (CN); Cong Yin, Sichuan (CN); Guangyou Xie, Sichuan (CN); Ting Li, Sichuan (CN); Juan Yang, Sichuan (CN); Yuan Fang, Sichuan (CN)

(73) Assignee: DONGFANG ELECTRIC CORPORATION, Sichuan (CN)

(21) Appl. No.: 14/239,411

(22) PCT Filed: Nov. 9, 2011
(86) PCT No.: PCT/CN2011/081971

§ 371 Date: Feb. 18, 2014

(30) Foreign Application Priority Data
Aug. 17, 2011 (CN) 201110236594.2

(51) Int. Cl. H01M 8/20

(52) U.S. Cl. CPC H01M 8/20
USPC 429/50; 429/62

(57) ABSTRACT

Provided is a flow battery system and a control method and device thereof. The control method of the flow battery system includes: monitoring the temperature of the flow battery system; judging whether the temperature of the flow battery system exceeds a predefined temperature value range or not; and if the temperature of the flow battery system exceeds the predefined temperature value range, adjusting the temperature of the flow battery system to make same fall into the predefined temperature value range. The present disclosure enables the flow battery system to operate within the predefined temperature value range, thus enhancing the charging and discharging efficiency of the flow battery system.

### FIELD OF THE DISCLOSURE

The present disclosure relates to the field of flow batteries, and in particular to a flow battery system and a control method and device thereof.

### BACKGROUND OF THE DISCLOSURE

A flow battery system, which is a system that performs an electrochemical Reduction-Oxidation (redox) reaction with electrolytes of metal ions with different valences, is able to realize conversion between chemical energy and electric energy efficiently. Such a battery system, which is safe and environment-friendly with long service life and high energy conversion efficiency etc., can be applied to a large-scale energy storage system of wind energy generation matched with photovoltaic generation, thus becoming one of the main approaches for peak shaving, valley filling and load balancing of a power grid. Therefore, flow battery systems have become the focus of researches on large-capacity energy storage batteries in recent years.

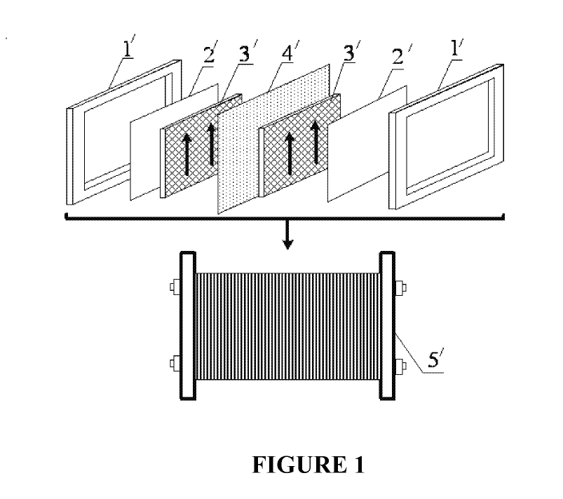

An all-vanadium redox flow battery system, for example, uses vanadium ions V2+/V3+ and V4+/V5+ as a positive and negative electrode redox couple of a battery, stores a positive electrode electrolyte and a negative electrode electrolyte in two electrolyte storage tanks respectively, drives the active electrolytes to a reaction zone (battery pile) with an acid-resistant liquid pump and then returns the active electrolytes to the electrolyte storage tanks to form a circulating flow loop to realize a charging and discharging process. In the all-vanadium redox flow battery energy storage system, the charging and discharging performance, especially the charging and discharging power and efficiency, of the whole system depends on the performance of the battery pile which is formed by stacking and compacting a plurality of individual batteries in turn and connecting the individual batteries in series, wherein a traditional individual flow battery as shown in FIG. 1 includes flow frames 1′, collector plates 2′, electrodes 3′, a diaphragm 4′, and a battery pile 5′ formed by stacking N individual flow batteries.

In a flow battery system, electrolytes of different valences have different solubility at different temperatures. For example, in an all-vanadium redox flow battery system, V5+ is easy to precipitate at high temperature to crystallize, and vanadium ions of other valences are easy to precipitate at low temperature to crystallize. The precipitates may cause blockage to a graphite felt, a pipeline and a liquid pump etc., thus reducing the charging and discharging efficiency of the battery system, or even stopping a battery from working normally. In addition, corrosion of battery materials and production of side reactions will be accelerated with the increase of the temperature, which requires higher sealing performance and corrosion resistance etc. of the battery.

At present, there is no effective solution for solving the problem that too high or too low temperatures of a flow battery system will cause crystallization of electrolytes in the system to further reduce the charging and discharging efficiency.

### SUMMARY OF THE DISCLOSURE

The main purpose of the present disclosure is to provide a flow battery system and a control method and device thereof to solve the problem that the charging and discharging efficiency of the flow battery system is low.

To realize the purpose, a control method of a flow battery system is provided according to an aspect of the present disclosure.

The control method of the flow battery system according to the present disclosure includes: monitor the temperature of the flow battery system; judge whether the temperature of the flow battery system exceeds a predefined temperature value range or not; and if the temperature of the flow battery system exceeds the predefined temperature value range, adjust the temperature of the flow battery system so that the temperature of the flow battery system is in the predefined temperature value range.

Further, monitoring the temperature of the flow battery system includes: before the flow battery system runs, monitor an external temperature of the flow battery system; and when the flow battery system runs, monitor an internal temperature of the flow battery system.

Further, monitoring the internal temperature of the flow battery system includes: monitor the temperature of a battery pile of the flow battery system; and/or monitor the temperature of an electrolyte flowing out of the battery pile.

Further, adjusting the temperature of the flow battery system includes: adjust the input of an electrolyte of the flow battery system; and/or adjust a temperature control medium, wherein a medium channel is provided in the flow battery system, and the temperature control medium is located in the medium channel.

Further, the input of the electrolyte of the flow battery system is adjusted by any one or more of the following methods: adjust the flow rate of the electrolyte of the flow battery system; and adjust the pipe diameter of an inlet or an outlet of the electrolyte of the flow battery system.

Further, when the temperature of the flow battery system is adjusted by adjusting the input of the electrolyte of the flow battery system, the temperature of an environment in which the flow battery system locates is lower than a predefined temperature value.

Further, the predefined temperature value is a boundary value of the predefined temperature value range.

Further, adjusting the temperature control medium so that the temperature of the flow battery system is in the predefined temperature value range includes: adjust the temperature of the temperature control medium; and/or adjust the flow rate of the temperature control medium in the medium channel.

Further, the temperature control medium includes any one of the following mediums: water, ethanol, an antifreeze, a cooling oil, air and nitrogen.

To realize the purpose above, a control device of a flow battery system is provided according to another aspect of the present disclosure.

The control device of the flow battery system according to the present disclosure includes: a monitoring device, configured to monitor the temperature of the flow battery system; a judging device, configured to judge whether the temperature of the flow battery system exceeds a predefined temperature value range or not; and an adjusting device configured to, when the temperature of the flow battery system exceeds the predefined temperature value range, adjust the temperature of the flow battery system so that the temperature of the flow battery system is in the predefined temperature value range.

Further, the monitoring device includes: a first monitoring sub-device configured to, before the flow battery system runs, monitor an external temperature of the flow battery system; and a second monitoring sub-device configured to, when the flow battery system runs, monitor an internal temperature of the flow battery system.

Further, the adjusting device includes: a first adjusting sub-device configured to adjust the input of an electrolyte of the flow battery system; and/or a second adjusting sub-device configured to adjust a temperature control medium, wherein a medium channel is provided in the flow battery system, and the temperature control medium is located in the medium channel.

Further, the first adjusting sub-device is configured to adjust the input of the electrolyte of the flow battery system by any one or more of the following methods: adjust the flow rate of the electrolyte of the flow battery system; and adjust the pipe diameter of an inlet or an outlet of the electrolyte of the flow battery system.

Further, when the temperature of the flow battery system is adjusted by adjusting the input of the electrolyte of the flow battery system, the temperature of an environment in which the flow battery system locates is lower than a predefined temperature value.

Further, the predefined temperature value is a boundary value of the predefined temperature value range.

Further, the second adjusting sub-device is configured to adjust the temperature control medium by any one of the following methods: adjust the temperature of the temperature control medium; and/or adjust the flow rate of the temperature control medium in the medium channel.

Further, the medium channel is provided in a collector plate or a flow frame.

To realize the purpose above, a flow battery system is provided according to another aspect of the present disclosure.

The flow battery system according to the present disclosure includes: a control device of any flow battery system provided by the present disclosure.

Through the present disclosure, a control method of a flow battery system is applied, including the following steps: monitor the temperature of the flow battery system; judge whether the temperature of the flow battery system exceeds a predefined temperature value range or not; and if the temperature of the flow battery system exceeds the predefined temperature value range, adjust the temperature of the flow battery system so that the temperature of the flow battery system is in the predefined temperature value range, thus enabling the flow battery system to operate within the predefined temperature value range and solving the problem that the charging and discharging efficiency of the flow battery system is reduced by crystallization of electrolytes in the system due to too high or too low temperatures to further enhance the charging and discharging efficiency of the flow battery system.

### DETAILED DESCRIPTION OF THE DISCLOSURE

The accompanying drawings, which constitute a part of the present application, are used for providing further understanding to the present disclosure. The exemplary embodiments of the present disclosure and the illustrations thereof are used for explaining the present disclosure, instead of constituting an improper limitation to the present disclosure. In the accompanying drawings:

FIG. 1 is a schematic diagram of an all-vanadium redox flow battery system according to a related technology;

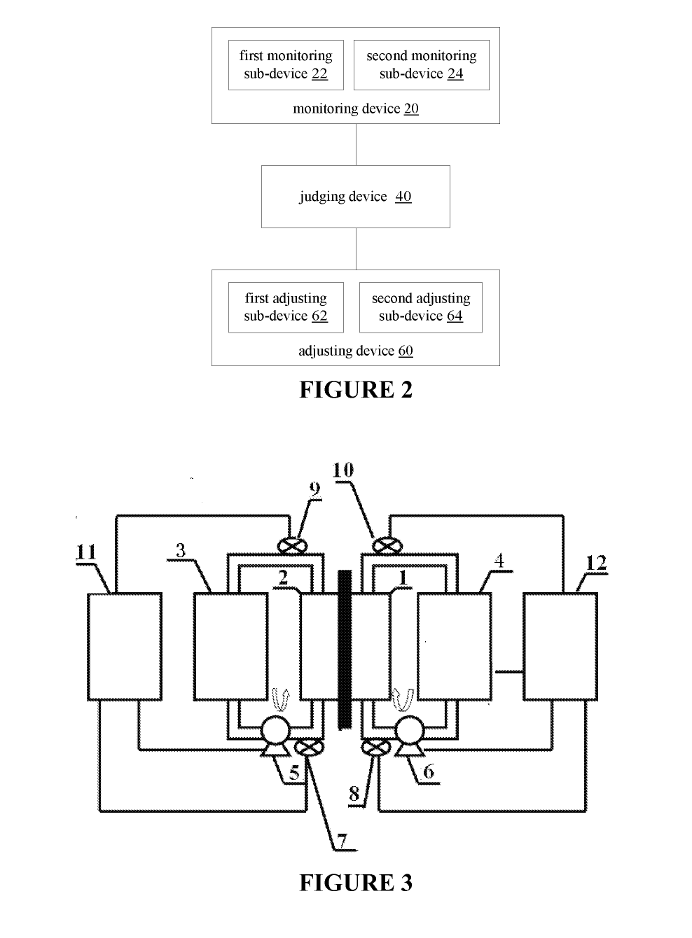

FIG. 2 is a block diagram of a control device of a flow battery system according to an embodiment of the present disclosure;

FIG. 3 is a structural diagram of a flow battery system according to an embodiment of the present disclosure;

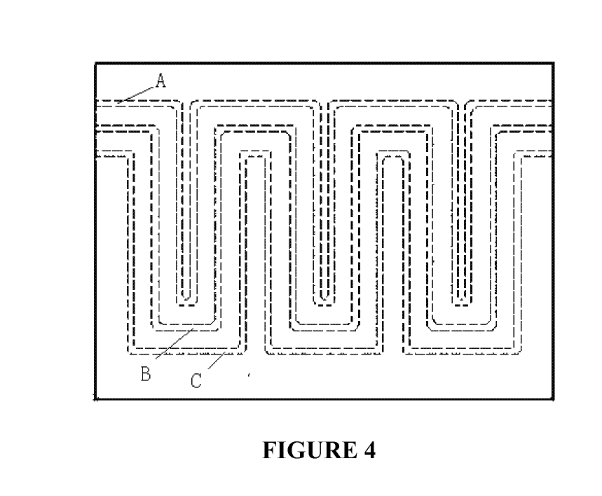

FIG. 4 is a front view of a collector plate of a flow battery system according to the first embodiment of the present disclosure;

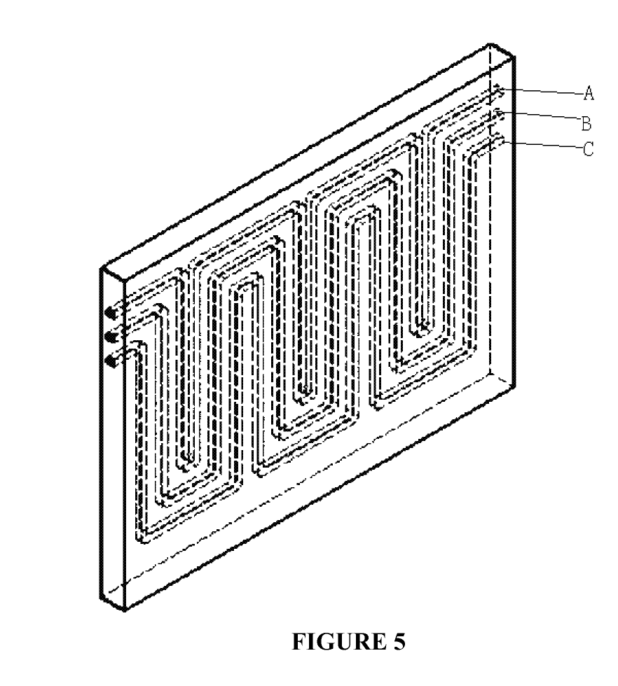

FIG. 5 is a stereogram of a collector plate of a flow battery system according to the first embodiment of the present disclosure;

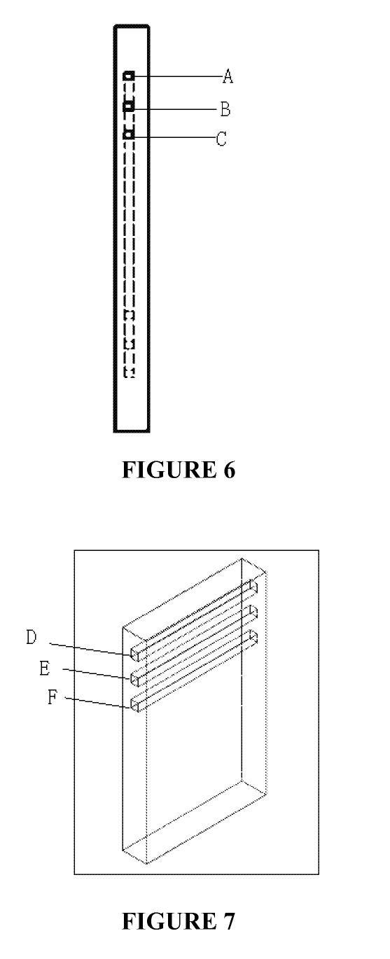

FIG. 6 is a side view of a collector plate of a flow battery system according to the first embodiment of the present disclosure;

FIG. 7 is a stereogram of a collector plate of a flow battery system according to the second embodiment of the present disclosure; and

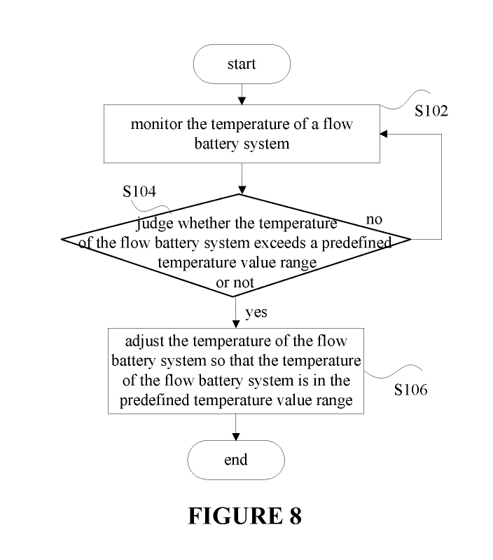

FIG. 8 is a flowchart of a control method of a flow battery system according to an embodiment of the present disclosure.

### DETAILED DESCRIPTION OF THE EMBODIMENTS

It should be noted that, if there is no conflict, the embodiments in the present application and the characteristics in the embodiments can be combined with one another. The present disclosure will be described in details below with reference to the accompanying drawings and in combination with the embodiments.

A flow battery system provided by an embodiment of the present disclosure will be introduced first.

The flow battery system includes a control device configured to monitor and control the temperature of the flow battery system. The temperature of the flow battery system can be adjusted efficiently and rapidly by the control device, thus ensuring that the working temperature of a battery is in an appropriate temperature value range, and avoiding electrolyte crystallization of the flow battery system due to too high or too low temperatures during a charging and discharging process to further enhance the charging and discharging efficiency and prolong the service life of the battery.

A control device of a flow battery system provided by an embodiment of the present disclosure will be described hereinafter.

FIG. 2 is a block diagram of a control device of a flow battery system according to an embodiment of the present disclosure. The control device of the flow battery system includes: a monitoring device 20, configured to monitor the temperature of the flow battery system; a judging device 40, configured to judge whether the temperature of the flow battery system exceeds a predefined temperature value range or not; and an adjusting device 60 configured to, when the temperature of the flow battery system exceeds the predefined temperature value range, adjust the temperature of the flow battery system so that the temperature of the flow battery system is in the predefined temperature value range.

To control the temperature of a battery pack, it needs to monitor the temperature of the battery pack first. In the present embodiment, the temperature of the flow battery system is monitored in real time by the monitoring device 20, and fed back to the judging device 40 according to a monitoring result of the temperature. Such feedback control may be implemented manually or may be automatic control. The judging device 40 judges whether the temperature monitored by the monitoring device 20 is in the predefined temperature range which refers to a temperature range in which the flow battery system works in a good condition and may be measured according to specific use conditions of the flow battery system or determined manually. When the judging device 40 judges that the temperature of the flow battery system is beyond the predefined temperature range, i.e. when the flow battery system works in a bad condition, the adjusting device 60 adjusts the temperature of the flow battery system so that the temperature of the flow battery system is in the predefined temperature value range, thus enabling the flow battery system to work in an appropriate temperature condition continuously, preventing a graphite felt, a pipeline and a liquid pump etc. from being blocked by crystallization because of too high or too low temperatures, enhancing the charging and discharging efficiency of the flow battery system, and prolonging the service life of the flow battery system.

Preferably, the monitoring device 20 includes: a first monitoring sub-device 22 configured to, before the flow battery system runs, monitor an external temperature of the flow battery system; and a second monitoring sub-device 24 configured to, when the flow battery system runs, monitor an internal temperature of the flow battery system. The external temperature of the flow battery system may refer to the temperature of an environment in which the flow battery system locates while the internal temperature may refer to a working temperature of the flow battery system, e.g. the temperature of a battery pile.

In the present embodiment, before the system runs, the first monitoring sub-device 22 monitors the external temperature of the system to acquire an environment temperature before the system is used. Optionally, when the external temperature is extremely low, the temperature of the system is increased appropriately so that the system can be used in a good condition. When the system runs, the second monitoring sub-device 24 monitors the internal temperature of the system to acquire a temperature change in real time when the system is used. When the internal temperature of the flow battery system is monitored, the battery pack may be measured directly, or the temperature of an electrolyte just flowing out of the battery pack may be measured.

FIG. 3 is a structural diagram of a flow battery system according to an embodiment of the present disclosure. As shown in FIG. 3, the direction of an arrow represents the flow direction of an electrolyte in a working state. The flow battery system includes a positive electrode circulating loop consisting of a battery pile positive electrode 1, a positive electrode storage tank 4 and a positive electrode liquid pump 6, and a negative electrode circulating loop consisting of a battery pile negative electrode 2, a negative electrode storage tank 3 and a negative electrode liquid pump 5. The flow battery system further includes a first temperature measuring device 7 and a second temperature measuring device 8 configured to monitor an environment temperature of the negative electrode circulating loop and an environment temperature of the positive electrode circulating loop respectively. The flow battery system further includes a third temperature measuring device 9 and a fourth temperature measuring device 10 configured to monitor the temperature of an electrolyte flowing out of a battery pile negative electrode and the temperature (the temperature reflects the temperature of the battery pack) of an electrolyte flowing out of a battery pile positive electrode respectively. The flow battery system further includes a first control device 11 configured to, according to the temperatures measured by the first temperature measuring device 7 and the third temperature measuring device 9, judge whether the temperatures exceed an optimal working temperature range of the system, and when the temperature of the system exceeds the optimal working temperature range thereof, adjust the input speed of the negative electrode liquid pump 5 to adjust the flow rate of the electrolyte so as to control the working temperature of the battery pack. The flow battery system further includes a second control device 12 configured to, according to the temperatures measured by the second temperature measuring device 8 and the fourth temperature measuring device 10, judge whether each temperature exceeds the optimal working temperature range of the system, and when the temperature of the system exceeds the optimal working temperature range thereof, adjust the input speed of the positive electrode liquid pump 6 to adjust the flow rate of the electrolyte so as to control the working temperature of the battery pack.

Preferably, the adjusting device 60 includes: a first adjusting sub-device 62 configured to adjust the input of an electrolyte of the flow battery system; and/or a second adjusting sub-device 64 configured to adjust a temperature control medium, wherein a medium channel is provided in the flow battery system, and the temperature control medium is located in the medium channel.

In the present embodiment, when the temperature of the flow battery system exceeds the predefined temperature value range, the input of the electrolyte of the flow battery system may be adjusted by the first adjusting sub-device. When the temperature of the flow battery system is too high, the input of the electrolyte is increased, and the battery pack is cooled by the electrolyte. Of course, it needs to ensure that the system runs normally while increasing the input of the electrolyte. The temperature of the flow battery system may be also adjusted back to the predefined temperature value range by adjusting the temperature control medium with the second adjusting sub-device. The temperature is increased or reduced by bringing in or taking away heat with the temperature control medium.

Preferably, the first adjusting sub-device is configured to adjust the input of the electrolyte of the flow battery system by any one or more of the following methods: adjust the flow rate of the electrolyte of the flow battery system; and adjust the pipe diameter of an inlet or an outlet of the electrolyte of the flow battery system.

In the present embodiment, the input of the electrolyte is changed by methods including change of all or part of the electrolytes in the battery pack or the battery pile, or change of the pipe diameter of the inlet or the outlet of the electrolyte and the like. However, it needs to ensure that the flow rates of the positive electrode electrolyte and the negative electrode electrolyte in a battery are matched.

Preferably, the second adjusting sub-device is configured to adjust the temperature control medium by any one of the following methods: adjust the temperature of the temperature control medium; and/or adjust the flow rate of the temperature control medium in the medium channel.

In the present embodiment, when an external temperature, i.e. an environment temperature is extremely low, the temperature of the temperature control medium is adjusted. For example, the temperature control medium is heated appropriately before the flow battery system runs to increase the temperature of the temperature control medium so that the flow battery system is used in a good condition, or the temperature control medium is heated first before the flow battery system runs, and then the flow rate of the temperature control medium in the medium channel is increased so that the flow battery system is used in a good condition. When the temperature of the flow battery system rises rapidly in use, the temperature of the temperature control medium is adjusted. For example, the temperature control medium is cooled appropriately when the flow battery system runs, and the battery pack may be cooled rapidly so that the flow battery system is used in a good condition, or the flow rate of the temperature control medium in the medium channel is increased so that the flow battery system is used in a good condition. In practical use, the heat taken away by the temperature control medium may be further utilized by an appropriate method.

Preferably, the medium channel is set in a collector plate or a flow frame.

The medium channel may be set in a collector plate or a flow frame of an individual battery to realize temperature control. According to different use demands and operation conditions etc., such individual batteries provided with medium channels are used in all or part of the constructed battery piles. When used in part of the constructed battery piles, the individual batteries provided with the medium channels may be distributed in the battery piles uniformly, or may be distributed in the battery pack in a non-uniform manner. If distributed in a non-uniform manner, the individual batteries provided with the medium channels may be located on any positions in the battery piles.

The medium channel is provided in the collector plate and the temperature control medium is added to the medium channel, e.g. a circulating cooling liquid. The used cooling liquid is water, ethanol, an antifreeze, a cooling oil, air and nitrogen etc. to realize cooling control for the battery pack. In a relatively typical mode, medium channels are uniformly provided in an individual collector plate in an individual battery, and a structure of the collector plate is as shown in FIG. 4 to FIG. 6. Three medium channels are provided in the individual collector plate: a first medium channel A, a second medium channel B and a third medium channel C, wherein the medium channels are obtained by various methods, e.g. compression molding etc., in the collector plate. In addition, when the collector plate is made of a material with good thermal conductivity, the medium channels may provide sufficient cooling efficiency through part of the positions of the collector plate, wherein the structure of the collector plate is as shown in FIG. 7, in which a fifth medium channel D, a sixth medium channel E and a seventh medium channel F only pass through an upper portion of the collector plate. Another method is to arrange the medium channels among a plurality of collector plates and a combined collector plate is used. Such a combined collector plate consists of more than two components that are matched with each other to be assembled into a collector plate in which corresponding medium channels are formed. The collector plate may be manufactured by materials including, but is not limited to a graphite plate, a conductive polymer, a conductive composite material, conductive ceramics, and a corrosion-resistant metal plate etc. The medium channels in the collector plate may be shaped before, during or after preparation of the collector plate according to different materials and different processing methods. The medium channels may be adjusted or combined randomly on the premise of ensuring that parameters including opening positions and shapes, channel shapes, positions, distribution, forms and materials etc. are able to satisfy use conditions and requirements. For example, the medium channels in the collector plate may be distributed uniformly as required, or distributed in a non-uniform manner. Two surfaces of such a collector plate provided with the medium channels may be plat plates. Electrolyte channels may be also designed correspondingly on the surfaces according to structural design of a battery. In a practical use process, a portion provided with a medium channel may be assembled in a battery pile or separately exposed out of the battery so as to facilitate management of the cooling liquid.

Finally, a control method of a flow battery system provided by an embodiment of the present disclosure will be described.

FIG. 8 is a flowchart of a control method of a flow battery system according to an embodiment of the present disclosure. As shown in FIG. 8, the method includes Step 102 to Step 106 as follows:

Step 102: monitor the temperature of the flow battery system;

preferably, monitoring the temperature of the flow battery system includes: before the flow battery system runs, monitor an external temperature of the flow battery system; and when the flow battery system runs, monitor an internal temperature of the flow battery system;

before the system runs, the external temperature of the system is monitored to acquire an environment temperature in real time before the system is used; optionally, when the external temperature is extremely low, the temperature of the system is increased appropriately so that the system can be used in a good condition; when the system runs, the internal temperature of the system is monitored to acquire a temperature change in real time when the system is used; when the internal temperature of the flow battery system is monitored, a battery pack may be measured directly, i.e. the temperature of a battery pile of the flow battery system is monitored. Or an electrolyte which just flows out of the battery pack may be also measured;

Step 104: judge whether the temperature of the flow battery system exceeds a predefined temperature value range or not; the predefined temperature value range is a temperature value range in which the flow battery system works in an optimal state; when the temperature of the flow battery system exceeds the predefined temperature value range, perform Step 106; otherwise, return to Step 102;

wherein the predefined temperature range refers to a temperature range in which the flow battery system works in a good condition and may be measured according to specific use conditions of the flow battery system or determined manually;

Step 106: adjust the temperature of the flow battery system so that the temperature of the flow battery system is in the predefined temperature value range.

Preferably, adjusting the temperature of the flow battery system includes: adjust the input of an electrolyte of the flow battery system; and/or adjust a temperature control medium, wherein a medium channel is provided in the flow battery system, and the temperature control medium is located in the medium channel.

When the temperature of the working flow battery system exceeds the predefined temperature value range, the input of the electrolyte of the flow battery system may be adjusted. When the temperature of the flow battery system is too high, the input of the electrolyte is increased, and the battery pack is cooled by the electrolyte. Of course, it needs to ensure that the system runs normally while increasing the input of the electrolyte. The temperature of the flow battery system may be also adjusted back to the predefined temperature value range by adjusting the temperature control medium. The temperature is increased or reduced by bringing in or taking away heat with the temperature control medium.

Preferably, the input of the electrolyte of the flow battery system is adjusted by any one or more of the following methods: adjust the flow rate of the electrolyte of the flow battery system; and adjust the pipe diameter of an inlet or an outlet of the electrolyte of the flow battery system.

The input of the electrolyte is changed by methods including change of all or part of the electrolytes in the battery pack or the battery pile, or change of the pipe diameter of the inlet or the outlet of the electrolyte and the like. However, it needs to ensure that the flow rates of the positive electrode electrolyte and the negative electrode electrolyte in a battery are matched.

Preferably, adjusting the temperature control medium so that the temperature of the flow battery system is in the predefined temperature value range includes: adjust the temperature of the temperature control medium; and/or adjust the flow rate of the temperature control medium in the medium channel.

When an external temperature, i.e. an environment temperature is extremely low, the temperature of the temperature control medium is adjusted. For example, the temperature control medium is heated appropriately before the flow battery system runs to increase the temperature of the temperature control medium so that the flow battery system is used in a good condition, or the flow rate of the temperature control medium in the medium channel is increased before the flow battery system runs so that the flow battery system is used in a good condition. When the temperature of the flow battery system rises rapidly in use, the temperature of the temperature control medium is adjusted. For example, the temperature control medium is cooled appropriately when the flow battery system runs, and the battery pack may be cooled rapidly so that the flow battery system is used in a good condition, or the flow rate of the temperature control medium in the medium channel is increased so that the flow battery system is used in a good condition. In practical use, the heat taken away by the temperature control medium may be further utilized by an appropriate method,

wherein the medium channel is provided in an internal component of the flow battery system, the temperature control medium is located in the medium channel, and the temperature control medium includes any one of the following mediums: water, ethanol, an antifreeze, a cooling oil, air and nitrogen.

In the present embodiment, the temperature of the flow battery system is monitored and adjusted in real time so that the flow battery system works in an appropriate temperature condition continuously. The flow battery system completes charging and discharging in environments with the most suitable external temperature and internal temperature so that the flow battery system works in an optimal state, thus enhancing the charging and discharging efficiency of the flow battery system and prolonging the serving life of the flow battery system.

Examples of flow battery systems designed by using embodiments of the present disclosure are illustrated as follows:

Example 1: preparation of an all-vanadium redox flow battery system provided with a novel temperature control technology, including: apply a highly conductive porous graphite felt as an electrode material, a conductive composite material as a collector plate and a Nafion membrane as an ion exchange membrane, prepare a cooling liquid channel in the middle of the collector plate, wherein the cooling liquid is distilled water, measure the battery temperature at 20° before working; when the temperature of a battery pack is higher than 40°, a temperature control system starts a liquid pump automatically to drive to cooling water to start circulating, thus cooling the battery pack; when the working temperature of the battery pack drops to a temperature within 35°, the temperature control system controls the liquid pump to stop the circulation of the cooling water.

Example 2: preparation of an all-vanadium redox flow battery system provided with a novel temperature control technology, including: apply a highly conductive porous graphite felt as an electrode material, a conductive composite material as a collector plate and a Nafion membrane as an ion exchange membrane, prepare a temperature control channel in the middle of the collector plate, wherein the temperature control medium is an antifreeze, measure the battery temperature at −10° before working, start the battery system and then heat the antifreeze first, maintain the temperature of the antifreeze at 20° and then drive a liquid pump to start circulation of the antifreeze, and a battery pack starts to work when the battery temperature is higher than 10°.

Example 3: preparation of an all-vanadium redox flow battery system provided with a novel temperature control technology, including: apply a highly conductive porous graphite felt as an electrode material, a graphite plate as a collector plate, a Nafion membrane as an ion exchange membrane, and take 30° as a defined working temperature value of the battery system; when an environment temperature is lower than the defined value and a working temperature is higher than the defined value, the flow rate of an electrolyte may be adjusted to reduce the temperature of a battery pile, wherein the defined value may be any value in the predefined temperature value range. Of course, the defined value may be also a boundary value or the minimum value of the predefined temperature value range; measure the environment temperature at 20°, and when the temperature of a battery pack is increased by more than 10°, increase the flow rate of the electrolyte by 3% to 15% to enhance the cooling effect; when the temperature is increased by less than 5°, adjust the flow rate of the electrolyte to be normal; measure the environment temperature at 26°, when the temperature of the battery pack is increased to 5°, improve the flow rate of the electrolyte by 3% to 15% to enhance the cooling effect.

It can be seen from the description above that the present disclosure realizes the following beneficial effect: a flow battery system can work in an environment with the most suitable temperature continuously, thus improving the charging and discharging efficiency of the flow battery system, and prolonging the service life of the flow battery system.

Obviously, those skilled in the art should understand that the modules or steps of the present disclosure may be implemented by general computing devices and centralized in a single computing device or distributed in a network consisting of multiple computing devices. Optionally, the modules or steps may be implemented by program codes executable by the computing devices, so that they may be stored in a storage device and executed by the computing devices, or they may be respectively made into integrated circuit modules or multiple modules or steps in the modules and steps may be made into a single integrated circuit module. By doing so, the present disclosure is not limited to any specific combination of hardware and software.

The above are only preferred embodiments of the present disclosure and should not be used to limit the present disclosure. For those skilled in the art, the present disclosure may have various modifications and changes. Any modifications, equivalent replacements, improvements and the like within the spirit and principle of the present disclosure shall fall within the scope of protection of the present disclosure.

1. A control method of a flow battery system, comprising:
monitoring the temperature of the flow battery system;
judging whether the temperature of the flow battery system exceeds a predefined temperature value range or not; and
if the temperature of the flow battery system exceeds the predefined temperature value range, adjusting the temperature of the flow battery system so that the temperature of the flow battery system is in the predefined temperature value range.

2. The control method of the flow battery system according to claim 1, wherein monitoring the temperature of the flow battery system comprises:
before the flow battery system runs, monitoring an external temperature of the flow battery system; and
when the flow battery system runs, monitoring an internal temperature of the flow battery system.

3. The control method of the flow battery system according to claim 2, wherein monitoring the internal temperature of the flow battery system comprises:
monitoring the temperature of a battery pile of the flow battery system; and/or
monitoring the temperature of an electrolyte flowing out of the battery pile.

4. The control method of the flow battery system according to claim 1, wherein adjusting the temperature of the flow battery system comprises:
adjusting the input of an electrolyte of the flow battery system; and/or
adjusting a temperature control medium, wherein a medium channel is provided in the flow battery system, and the temperature control medium is located in the medium channel.

5. The control method of the flow battery system according to claim 4, wherein the input of the electrolyte of the flow battery system is adjusted by any one or more of the following methods:
adjusting the flow rate of the electrolyte of the flow battery system; and
adjusting the pipe diameter of an inlet or an outlet of the electrolyte of the flow battery system.

6. The control method of the flow battery system according to claim 4, wherein adjusting the temperature control medium comprises:
adjusting the temperature of the temperature control medium; and/or
adjusting the flow rate of the temperature control medium in the medium channel.

7. The control method of the flow battery system according to claim 4, wherein the temperature control medium comprises any one of the following mediums:
water, ethanol, an antifreeze, a cooling oil, air and nitrogen.

8. The control method of the flow battery system according to claim 4, wherein when the temperature of the flow battery system is adjusted by adjusting the input of the electrolyte of the flow battery system, the temperature of an environment in which the flow battery system locates is lower than a predefined temperature value.

9. The control method of the flow battery system according to claim 8, wherein the predefined temperature value is a boundary value of the predefined temperature value range.

10. A control device of a flow battery system, comprising:
a monitoring device, configured to monitor the temperature of the flow battery system;
a judging device, configured to judge whether the temperature of the flow battery system exceeds a predefined temperature value range or not; and
an adjusting device configured to, when the temperature of the flow battery system exceeds the predefined temperature value range, adjust the temperature of the flow battery system so that the temperature of the flow battery system is in the predefined temperature value range.

11. The control device of the flow battery system according to claim 10, wherein the monitoring device comprises:
a first monitoring sub-device configured to, before the flow battery system runs, monitor an external temperature of the flow battery system; and
a second monitoring sub-device configured to, when the flow battery system runs, monitor an internal temperature of the flow battery system.

12. The control device of the flow battery system according to claim 10, wherein the adjusting device comprises:
a first adjusting sub-device configured to adjust the input of an electrolyte of the flow battery system; and/or
a second adjusting sub-device configured to adjust a temperature control medium, wherein a medium channel is provided in the flow battery system, and the temperature control medium is located in the medium channel.

13. The control device of the flow battery system according to claim 12, wherein the first adjusting sub-device is configured to adjust the input of the electrolyte of the flow battery system by any one or more of the following methods:
adjusting the flow rate of the electrolyte of the flow battery system; and
adjusting the pipe diameter of an inlet or an outlet of the electrolyte of the flow battery system.

14. The control device of the flow battery system according to claim 12, wherein the second adjusting sub-device is configured to adjust the temperature control medium by any one of the following methods:
adjusting the temperature of the temperature control medium; and/or
adjusting the flow rate of the temperature control medium in the medium channel.

15. The control device of the flow battery system according to claim 12, wherein the medium channel is provided in a collector plate or a flow frame.

16. The control device of the flow battery system according to claim 12, wherein when the temperature of the flow battery system is adjusted by adjusting the input of the electrolyte of the flow battery system, the temperature of an environment in which the flow battery system locates is lower than a predefined temperature value.

17. The control device of the flow battery system according to claim 16, wherein the predefined temperature value is a boundary value of the predefined temperature value range.

18. A flow battery system, comprising the control device of the flow battery system according to claim 10.
